(19) United States
(12) Patent Application Publication
(10) Pub. No.: US 2010/0081040 A1
(43) Pub. Date: Apr. 1, 2010

(54) SAFETY DEVICE FOR RECHARGEABLE BATTERY

(76) Inventor: CHING-TUAN WANG, Taichung (TW)

Correspondence Address: PHILLIP LIU, 6980, WHITEOAK DRIVE, RICHMOND, BC, V7E 4Z9, CA

(21) Appl. No.: 12/242,872

(22) Filed: Sep. 30, 2008

(51) Int. Cl. H01M 2/12

(52) U.S. Cl. 429/56

(57) ABSTRACT

A safety device for a rechargeable battery includes a safety plate having multiple first notches defined in an underside thereof and a positioning plate is securely engaged with the central hole defined through the safety plate. The positioning plate has its outer periphery securely engaged with the inside of the casing of the battery and includes multiple second notches defined in an underside thereof. A cap has its outer periphery connected to the positioning plate and includes apertures defined therethrough. The safety plate is broken at the first notches to allow the positioning plate to be separated from the safety plate when the inner pressure exceeds the pre-set pressure when the battery is overly charged. When the pressure continues to increase, the positioning plate is broken at the second notches and the pressure within the cap can be escaped via the apertures.

### FIELD OF THE INVENTION

The present invention relates to a safety device for a rechargeable battery and ensures that the battery does not explode when being overcharged.

### BACKGROUND OF THE INVENTION

A conventional rechargeable lithium battery has a higher operation voltage and can be used for longer period of time so that it is widely used in electronic appliances such as cellular phones and digital cameras. However, if the lithium battery is overly charged, the pressure and temperature inside the battery raise rapidly and might explode.

A conventional safety device for the rechargeable battery is shown in FIGS. 1 and 1A, and also disclosed in U.S. Pat. No. 7,186,477, generally includes a cap 1, a safety plate 2, an isolation plate 3, an annular plate 4 and a mediate part 5, wherein the mediate part 5 is connected to the open top of the casing 9 of the battery and the annular plate 4 is located within a central hole of the mediate part 5. The isolation plate 3 is located on the annular plate 4 and the safety plate 2 is located on the isolation plate 3. The cap 1 is engaged with the mediate part 5 and located above the annular plate 4 so as to seal the top of the battery. The cap 1 is the position pole and the casing 9 is the negative pole of the battery. The safety plate 2 has a recessed portion in the center thereof and the annular plate 4 is engaged with the recessed portion of the safety plate 2.

As shown in FIG. 2, when the battery is overly charged and exceeds the pre-set pressure, the recessed portion of the safety plate 2 is deformed and disengaged from the annular plate 4 so that the loop is opened and the charging process is terminated. By this way, the battery does not explode.

The safety plate 2 plays two different roles in the conventional battery, one is to complete the loop and the other is to prevent from explosion. However, these two roles are conflicted to each other. The engagement between the safety plate 2 and the annular plate 4 has to be secured enough to ensure the loop works normally. On the other hand, the engagement cannot be too secured such that the safety plate 2 cannot be disengaged from the annular plate 4 when being overly charged. It is difficult to control the engagement between the safety plate 2 and the annular plate 4 when manufacturing the battery. If the engagement is not strong enough, the battery cannot be fully charged, and the battery might explode if the engagement is too strong.

The present invention intends to provide a safety device for a rechargeable battery and the device includes at least two stages of safety control to ensure that the battery is safe even being overly charged.

### SUMMARY OF THE INVENTION

The present invention relates to a safety device for a rechargeable battery and the safety device comprises a casing including a horizontal portion and an upright portion extending from a periphery of the horizontal portion. A safety plate having a central note is engaged with an inner periphery of the horizontal portion and a plurality of holes are defined through the safety plate. A plurality of V-shaped first notches are defined between and in communication with the holes. A positioning plate is located above the safety plate and an isolation plate is sandwiched between the horizontal portion and the positioning plate. The positioning plate includes a round and inclined body at the central portion thereof and a tubular portion is formed in the center of the positioning plate. The tubular portion is engaged with the central hole of the safety plate and a seal plate is connected to an end of the tubular portion to seal the central hole. A first annular groove is defined between a periphery of the seal plate and the inclined body. An inner periphery of the safety plate is engaged with the first annular groove of the positioning plate. A clamp part extends inward from an outer periphery of the positioning plate so as to define a second annular groove. An outer periphery of a cap is engaged with the second annular groove and a Nickel plate is located between the outer periphery of the cap and the inclined body. The cap includes multiple apertures defined therethrough. A protrusion extending inward from an inside of the upright portion and the clamp part is engaged with the protrusion to position the positioning plate in the casing. The positioning plate includes second notches defined in an underside thereof and each of the second notches is a V-shaped notch. The second notches are located beside an inner periphery of the isolation plate.

The safety plate is broken at the first notches to separate the safety plate and the positioning plate to determine the charging process. The positioning plate is broken at the second notches if the pressure is still high and the apertures in the cap allow the pressure between the cap and the positioning plate to escape to effectively avoid explosion of the battery.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show a conventional rechargeable battery;

FIG. 1A is an enlarged cross sectional view to show the circled part in FIG. 1;

FIG. 2 is a cross sectional view to show that the safety plate is separated from the annular plate by the pressure in the conventional rechargeable battery;

FIG. 3 is a cross sectional view to show the safety device for a rechargeable battery of the present invention;

FIG. 3A is an enlarged cross sectional view to show the engagement between the safety plate and the positioning plate of the safety device for a rechargeable battery of the present invention;

FIG. 3B is an enlarged cross sectional view to show the second notches defined in the underside of the positioning plate of the safety device for a rechargeable battery of the present invention;

FIG. 4 is a bottom view of the safety plate of the safety device for a rechargeable battery of the present invention;

FIG. 5 is a bottom view of the positioning plate of the safety device for a rechargeable battery of the present invention;

FIG. 6 is a bottom view of the cap of the safety device for a rechargeable battery of the present invention;

FIG. 7 is a cross sectional view to show that the safety plate is broken at the first notches and separated from the positioning plate of the safety device for a rechargeable battery of the present invention, and

FIG. 8 is a cross sectional view to show that the positioning plate is broken at the second notches and deformed toward the cap of the safety device for a rechargeable battery of the present invention.

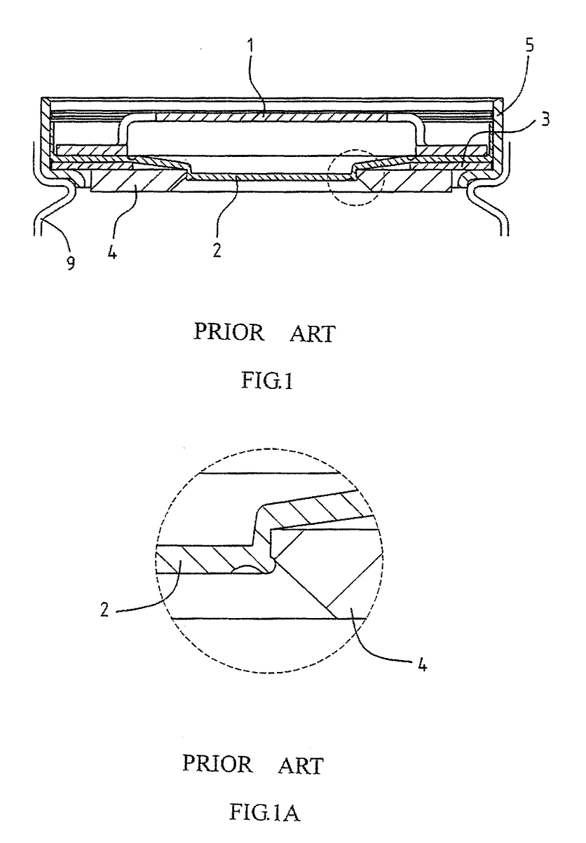

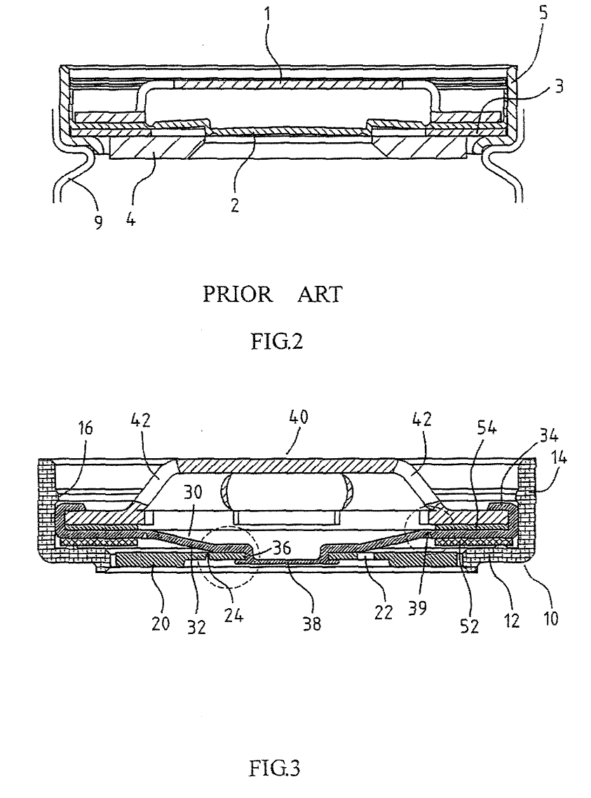

### DETAILED DESCRIPTION OF THE PREFERRED EMBODIMENT

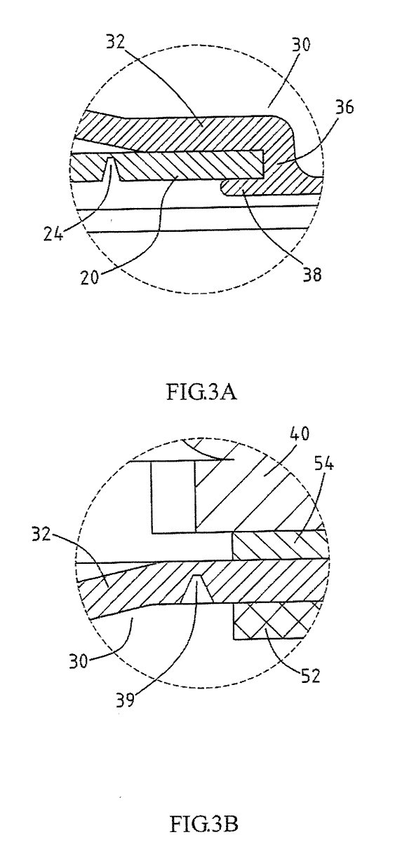

Referring to FIG. 3, the safety device for a rechargeable battery of the present invention comprises a casing 10 which includes a horizontal portion 12 and an upright portion 14 which extends from a periphery of the horizontal portion 12. The casing 10 receives the material of Lithium battery as known in the art.

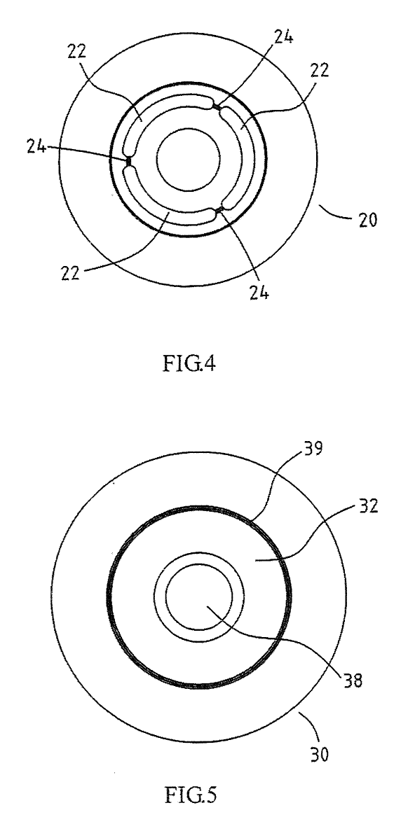

A safety plate 20 has a central hole and is engaged with an inner periphery of the horizontal portion 12. The safety plate 20 includes a plurality of elongate holes 22 defined therethrough as shown in FIG. 4 and a plurality of first notches 24 are defined between the holes 22. Each first notch 24 is a V-shaped notch and defined in an underside of the safety plate 20 as shown in FIG. 3A. The holes 22 are in communication with the first notches 22.

A positioning plate 30 is located above the safety plate 20 and an isolation plate 52 is sandwiched between the horizontal portion 12 and the positioning plate 30. The positioning plate 30 includes a round and inclined body 32 at a central portion thereof and a tubular portion 36 is formed in the center of the positioning plate 30. The tubular portion 36 is engaged with the central hole of the safety plate 20 and a seal plate 38 is connected to an end of the tubular portion 36 to seal the central hole of the safety plate 20. A first annular groove is defined between a periphery of the seal plate 38 and the inclined body 32. An inner periphery of the safety plate 20 is engaged with the first annular groove of the positioning plate 30 as shown in FIG. 3A. A clamp part 34 extends inward from an outer periphery of the positioning plate 30 so as to define a second annular groove. An outer periphery of a cap 40 is engaged with the second annular groove and a Nickel plate 54 is located between the outer periphery of the cap 40 and the inclined body 32.

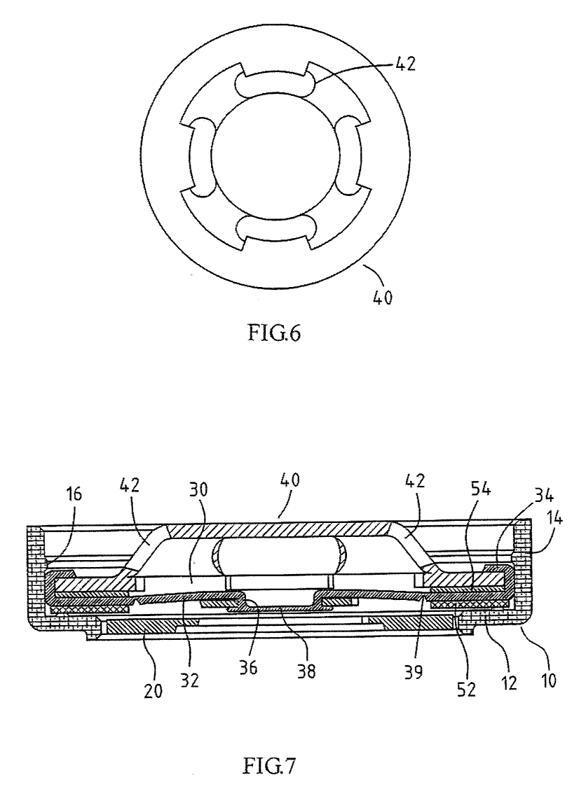

A protrusion 16 extends inward from an inside of the upright portion 14 and the clamp part 34 is engaged with the protrusion 16 to position the positioning plate 30 in the casing 10. As shown in FIG. 5, the positioning plate 30 includes second notches 39 defined in an underside thereof and each of the second notches 39 is a V-shaped notch. The second notches 39 are located beside an inner periphery of the isolation plate 52 as shown in FIG. 3B. The cap 40 includes multiple apertures 42 defined therethrough as shown in FIGS. 3 and 6.

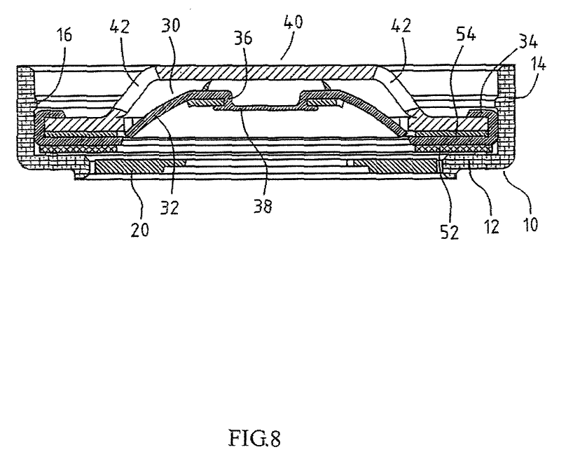

As shown in FIG. 7, when overly charging the battery, the pressure in the battery exceeds the pre-set pressure, the pressure applies to the seal plate 38, the safety plate 20 and the positioning plate 30, the safety plate 20 is broken at the first notches 24 and separated from the positioning plate 30 to terminate the charging process. When the safety plate 20 is broken at the first notches 24, the tubular portion of the positioning plate 30 moves toward the cap 40 and the pressure between the cap 40 and the positioning plate 30 can be escaped from the apertures 42 of the cap 40 to avoid the battery from explosion.

As shown in FIG. 8, after the charging process is terminated, the chemical action in the battery is still on and generates extra pressure which pushes the positioning plate 30 and the positioning plate 30 is broken at the second notches 39 to farther protect the battery from exploding. Again, the pressure between the cap 40 and the positioning plate 30 can be released via the apertures 42.

It is noted that to control the depth of the first and second notches 24, 39 and the material for the safety plate 20 and the positioning plate 30 is easy so that the pressure that is able to break the safety plate 20 and the position plate 30 can be controlled. By the safety device of the present invention, the rechargeable battery can be effectively controlled to prevent from explosion when overly charged.

While we have shown and described the embodiment in accordance with the present invention, it should be clear to those skilled in the art that further embodiments may be made without departing from the scope of the present invention.

What is claimed is:

1. A safety device for a rechargeable battery, comprising:
a casing including a horizontal portion and an upright portion which extends from a periphery of the horizontal portion;
a safety plate having a central hole and engaged with an inner periphery of the horizontal portion, a plurality of holes defined through the safety plate and a plurality of first notches defined between the holes, each first notch being a V-shaped notch and defined in an underside of the safety plate, the holes communicating with the first notches, and
a positioning plate located above the safety plate and an isolation plate sandwiched between the horizontal portion and the positioning plate, the positioning plate including a round and inclined body at a central portion thereof and a tubular portion being formed in the center of the positioning plate, the tubular portion engaged with the central hole of the safety plate and a seal plate connected to an end of the tubular portion to seal the central hole of the safety plate, a first annular groove defined between a periphery of the seal plate and the inclined body, an inner periphery of the safety plate being engaged with the first annular groove of the positioning plate, a clamp part extending inward from an outer periphery of the positioning plate so as to define a second annular groove, an outer periphery of a cap being engaged with the second annular groove and a Nickel plate located between the outer periphery of the cap and the inclined body, the cap including multiple apertures defined therethrough, a protrusion extending inward from an inside of the upright portion and the clamp part being engaged with the protrusion to position the positioning plate in the casing, the positioning plate including second notches defined in an underside thereof and each of the second notches being a V-shaped notch, the second notches located beside an inner periphery of the isolation plate.
